(19) United States
(12) Patent Application Publication
(10) Pub. No.: US 2026/0055564 A1
(43) Pub. Date: Feb. 26, 2026

(54) MULTIMODAL DEBRIS CLEARING SYSTEM FOR AUTONOMOUS VEHICLES AND METHODS FOR CONTROLLING A DEBRIS CLEARING SYSTEM

(71) Applicant: Torc Robotics, Inc., Blacksburg, VA (US)

(72) Inventors: Savio Pereira, Austin, TX (US); Akshay Pai Raikar, Austin, TX (US); Joseph R. Fox-Rabinovitz, Austin, TX (US)

(21) Appl. No.: 18/814,138

(22) Filed: Aug. 23, 2024

(51) Int. Cl. E01H 1/08; B60R 19/54

(52) U.S. Cl. CPC E01H 1/0818; B60R 19/54

(57) ABSTRACT

A multimodal debris clearing system, and methods for controlling the same, for an autonomous vehicle. The multimodal debris clearing system includes multiple modes of clearing debris from the path of an autonomous vehicle including, but not limited, the directed application of airflow, a brush to push or sweep away debris, and a magnet to collect debris. The multimodal debris clearing system may include multiple air ducts aligned across the front or near the wheel wells of the autonomous vehicle. The multimodal debris clearing system can be configured to be selectively, and automatically, deployed in response to conditions sensed by the sensors of the autonomous vehicle. The multimodal debris clearing system can deployed in response to the sensors of the autonomous vehicle detecting debris in the path of the autonomous vehicle, the speed of the autonomous vehicle, or a combination thereof.

### TECHNICAL FIELD

The present disclosure relates generally to the field of obstacle avoidance and sensor systems for autonomous vehicles. Specifically, the present disclosure relates to a multimodal debris clearing system and methods for controlling the same.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

When operating in real world conditions, an autonomous vehicle will regularly encounter debris, such as shreds of blown out tires, nails and screws, glass shards, paper and plastic rubbish, metal scraps, and similar objects, in the autonomous vehicle's path of travel. In many instances, it will be desirable for the autonomous vehicle to avoid the debris to prevent damage to the autonomous vehicle. In some cases when debris is encountered, the autonomous vehicle may simply adjust its speed and path of travel to navigate around the debris. In other cases, though, it may not be possible to navigate around the debris for any number of reasons including, but not limited to, debris being strewn across the entirety of the road, traffic or other obstacles adjacent to the autonomous vehicle, or other conditions that prevent the autonomous vehicle from safely navigating around the debris. However, in a situation where it is not possible to navigate around the debris, and especially when there is no operator present, an autonomous vehicle will need to contend with certain debris without driving through the debris and risking damage to the autonomous vehicle and without stopping to wait for the debris to be removed, which may cause shipping delays or other logistical issues.

Accordingly, there exists a need to incorporate a debris clearing system with an autonomous vehicle to aid in obstacle avoidance when it is not possible or practical for the autonomous vehicle to navigate around the debris.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

The present disclosure relates to a multimodal debris clearing system for autonomous vehicle and methods for controlling the same.

In one aspect, a multimodal debris clearing system for a vehicle. The multimodal debris clearing system includes an airflow generator, one or more multimodal debris clearing apparatuses in airflow communication with the airflow generator, wherein each of the multimodal debris clearing apparatuses includes a duct configured to direct airflow toward a front end of the vehicle, one or more secondary debris clearing modes attached to at least one of the multimodal debris clearing apparatuses, and a debris monitoring and clearing module programmed with control logic to activate the airflow generator when debris is detected.

In some aspects, the multimodal debris clearing system includes a duct positioning system configured to move the multimodal debris clearing apparatuses between a retracted position and a deployed position. In such aspects, a control logic of the debris monitoring and clearing module is further programmed to activate the duct positioning system when debris is detected.

In some aspects, the multimodal debris clearing system includes an airflow splitter positioned between an airflow generator and the multimodal debris clearing apparatuses.

In some aspects, the multimodal debris clearing system is positioned at a front end of a vehicle. In such aspects, the multimodal debris clearing system may be (i) positioned in front of each front wheel of the vehicle or (ii) spaced across the front end of the vehicle.

In some aspects, the multimodal debris clearing system includes an air outlet at a first end of the multimodal debris clearing apparatus that is divided into two or more openings by a divider. In such aspects, the air outlet may have a V-shape and the divider may be positioned to direct the airflow outward from a center line of the V-shape of the air outlet.

In some aspects, the multimodal debris clearing system includes one or more selectively activated airflow valves.

In some aspects, the multimodal debris clearing system includes a selectively activated flap mechanism inside of a duct of the multimodal debris clearing apparatus. In such aspects, the flaps of a plurality of ducts may be activated in a pattern to impart an airflow sweeping effect as the airflow exits the multimodal debris clearing apparatuses.

In some aspects, the multimodal debris clearing system includes secondary debris clearing modes that (i) are attached to a multimodal debris clearing apparatus and (ii) supplement the airflow cleaning mode. In such aspects, the secondary debris clearing modes may include, but are not limited to, a brush, a magnet, or a combination thereof. In such aspects, the secondary debris clearing modes may be removably attached to the multimodal debris clearing apparatus.

In another aspect, a multimodal debris clearing system for a vehicle. The multimodal debris clearing system includes an airflow generator, one or more multimodal debris clearing apparatuses in airflow communication with the airflow generator, wherein each of the multimodal debris clearing apparatuses includes a duct configured to direct airflow toward a front end of the vehicle via an air outlet formed at a first end of the duct, a duct positioning system configured to move the multimodal debris clearing apparatuses between a retracted position and a deployed position, and a debris monitoring and clearing module programmed with control logic to activate both the airflow generator and the duct positioning system when debris is detected.

In some aspects, the debris monitoring and clearing module of the multimodal debris clearing system is programmed with additional control logic to activate both the airflow generator and the duct positioning system when the vehicle is traveling below a threshold speed.

In some aspects, the multimodal debris clearing system includes one or more secondary debris clearing modes removably attached to a multimodal debris clearing apparatus.

In some aspects, the multimodal debris clearing system includes an adjustable pipe attached a second of the duct to enable the duct positioning system moving each of the multimodal debris clearing apparatuses between the retracted position and the deployed position

In yet another aspect, a method of deploying a debris clearing system of a vehicle. The method includes, monitoring for a debris in a path of the vehicle, detecting the debris in the path of the vehicle, wherein the debris is a detected debris, deploying the debris clearing system, and clearing the detected debris from the path of the vehicle using one or modes of clearing equipped on the debris clearing system.

In some aspects, the method also includes detecting a speed of the vehicle, wherein deploying the debris clearing system is limited to when the speed of the vehicle is at or below a threshold speed.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is a schematic perspective view of a multimodal debris clearing apparatus, in accordance with an embodiment of the present disclosure;

FIG. 5A is a schematic front elevation view of an autonomous vehicle with one or more units of the multimodal debris clearing apparatus of FIG. 4 across the front of the autonomous vehicle, in accordance with an embodiment of the present disclosure;

FIG. 5B is a schematic front elevation view of an autonomous vehicle with one or more units of the multimodal debris clearing apparatus of FIG. 4 in front of the front wheels of the autonomous vehicle, in accordance with an embodiment of the present disclosure;

FIG. 6A is a schematic bottom plan view of an autonomous vehicle with one or more units of the multimodal debris clearing apparatus of FIG. 4 across the front of the autonomous vehicle, in accordance with an embodiment of the present disclosure;

FIG. 6B is a schematic bottom plan view of an autonomous vehicle with one or more units of the multimodal debris clearing apparatus of FIG. 4 in front of the front wheels of the autonomous vehicle, in accordance with an embodiment of the present disclosure;

FIG. 7 is a schematic side elevation view of an autonomous vehicle with the multimodal debris clearing apparatus of FIG. 4 deployed at the front of the autonomous vehicle, in accordance with an embodiment of the present disclosure;

FIG. 8A is a schematic view of the multimodal debris clearing apparatus of FIG. 4 in a raised or retracted position, in accordance with an embodiment of the present disclosure;

FIG. 8B is a schematic view of the multimodal debris clearing apparatus of FIG. 4 in a lowered or deployed position, in accordance with an embodiment of the present disclosure;

FIG. 9 is a schematic view of a multimodal debris system, in accordance with an embodiment of the present disclosure;

FIG. 10 is a schematic bottom plan view of an autonomous vehicle equipped with a multimodal debris system illustrating an exemplary pattern of airflow from the multimodal debris system, in accordance with an embodiment of the present disclosure; and

FIG. 11 is an exemplary flow chart illustrating the activation of a multimodal debris system, in accordance with an embodiment of the present disclosure.

Corresponding reference numbers or characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

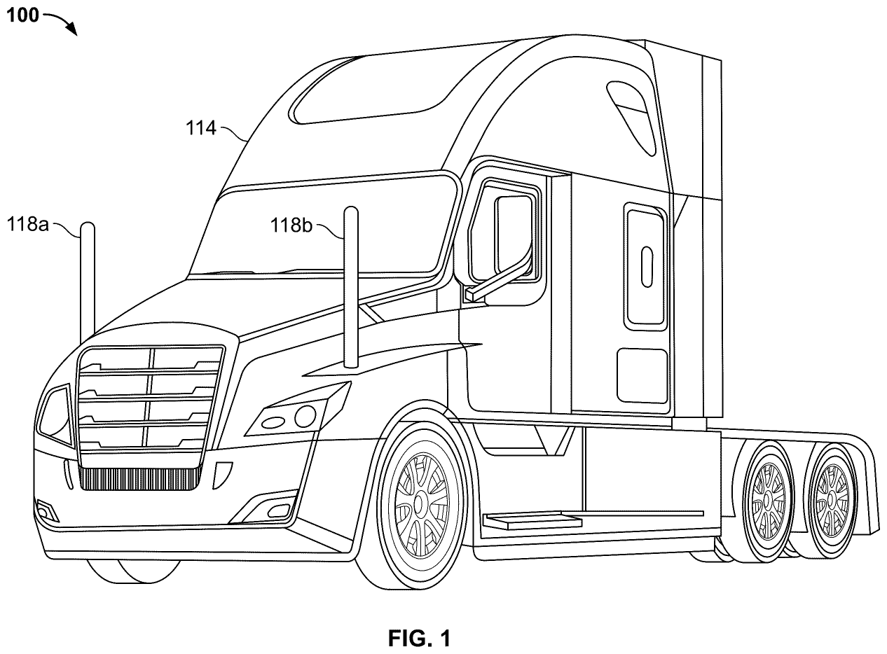

As described herein, a multimodal debris clearing system and methods for controlling the same in combination with an autonomous vehicle. In various embodiments, the debris clearing system is selectively deployable according to one or more conditions sensed by one or more sensors of the autonomous vehicle. The multimodal debris clearing system may be utilized to clear or remove debris from the proximity of the autonomous vehicle. Clearing or removing debris from the proximity of the autonomous vehicle reduces the chance that such debris will damage the autonomous vehicle. Additionally, removing debris from the proximity of the autonomous vehicle can enhance vehicle efficiency by enabling the autonomous vehicle on a particular path of travel without need to detour to a less efficient or more time-consuming route. Various embodiments in the present disclosure are described with reference to FIGS. 1-11 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

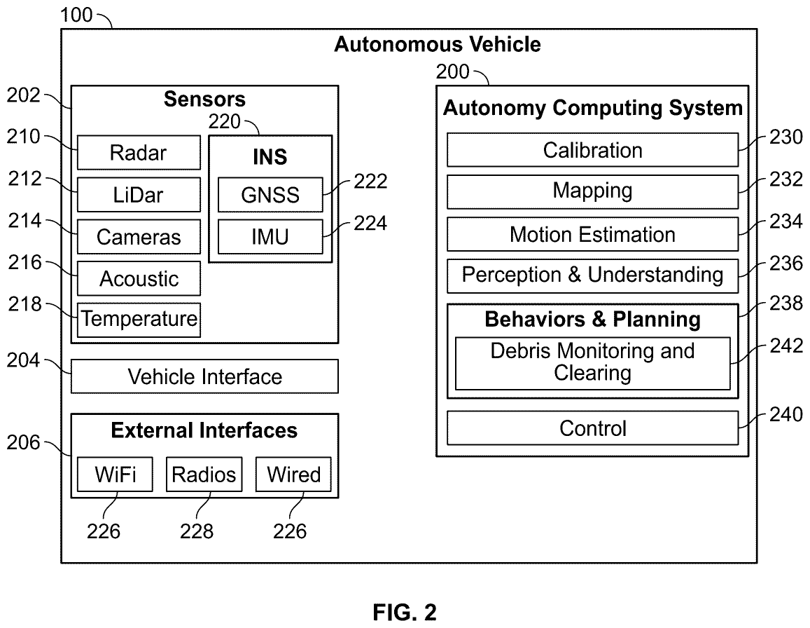

The vehicle 100 may be an autonomous vehicle, in which case the vehicle 100 may omit the steering wheel and the steering column to steer the vehicle 100. Rather, the vehicle 100 may be operated by an autonomy computing system 200 (see FIG. 2) of the vehicle 100 based on data collected by a sensor network including one or more sensors (e.g. sensors 202), which may include one or more sensors 118a, 118b attached to the exterior of the vehicle 100.

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound, microphones, etc.), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a debris monitoring and clearing module 242. The debris monitoring and clearing module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The debris monitoring and clearing module 242 may perform one or more tasks including, but not limited to, receiving data corresponding to debris detected by the sensors 202 that is in the path of the vehicle, as well as the speed of the vehicle. The debris monitoring and clearing module 242 can use such data to determine when and how to deploy the multimodal debris clearing apparatus.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

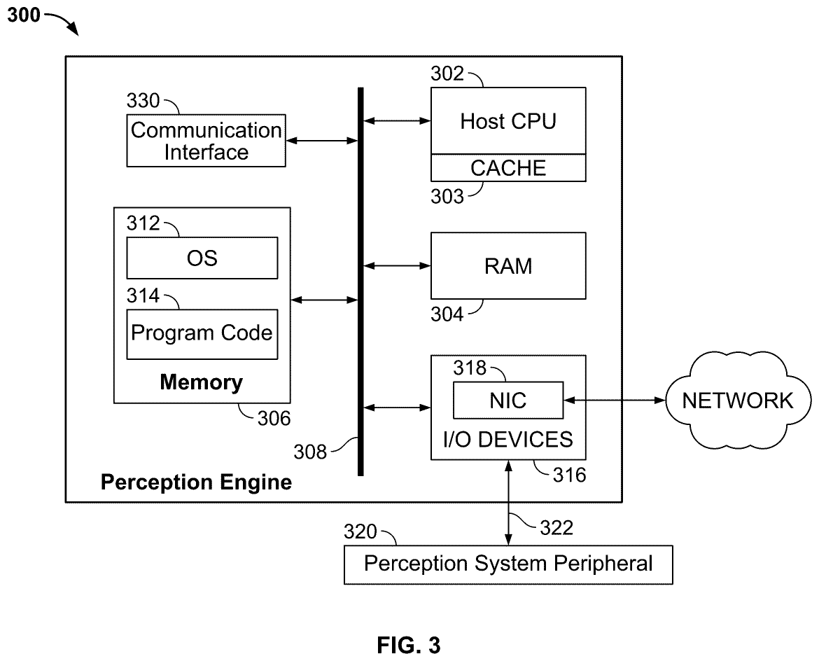

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

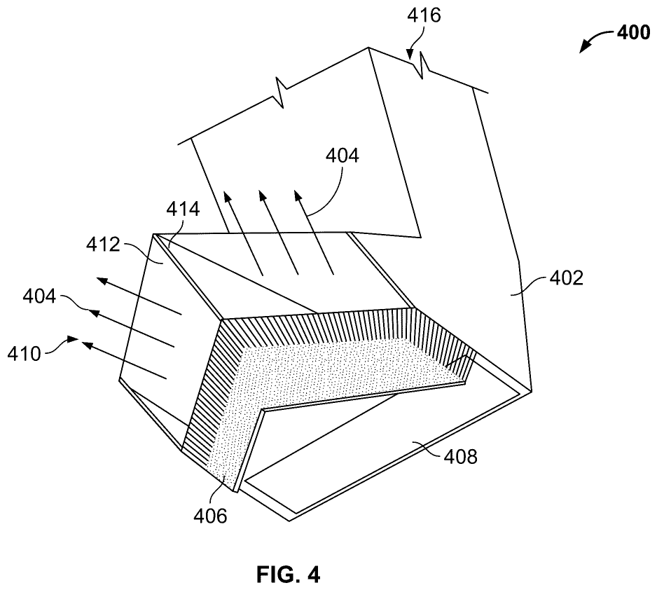

FIG. 4 is a schematic perspective view of a multimodal debris clearing apparatus 400 for clearing or removing debris from the proximity of an autonomous vehicle. As shown in FIG. 4, the multimodal debris clearing apparatus 400 may be configured to utilize multiple modes of clearing or removing debris including, but not limited to, airflow 404, a brush 406, and a magnet 408. In at least one example embodiment, the multimodal debris clearing apparatus 400 includes a duct 402, which may be in the form of a pipe, boot, or similar conduit. In some embodiments, at least a portion of a bottom of the duct 402 is closed to provide a surface for attaching the brush 406 and the magnet 408 to the duct 402. By positioning the brush 406 and the magnet 408 on the bottom of the duct 402, the brush 406 and the magnet 408 can be placed parallel to the road surface when the multimodal debris clearing apparatus 400 is deployed. The duct 402 has a first end 410 with an air outlet 412 to direct the airflow 404 from the multimodal debris clearing apparatus 400. In some embodiments, the air outlet 412 may be divided into two or more openings by one or more dividers 414. In an example embodiment, the air outlet 412 may be V-shaped and the divider positioned to direct airflow 404 outward from a center line of the air outlet 412. As an illustrative example, the duct 402 may be generally L-shaped, with the air outlet 412 being formed on the front of the distal end of the arm of the L-shaped duct to direct airflow 404 forward. In other examples, the air outlet 412 could be formed in the bottom surface of the duct 402 to direct airflow 404 downward. The duct 402 also has a second end 416 that that is in airflow communication with an air source or air supply, for example an air blower or other air supply system. Airflow communication means two or more components being connected or linked in a manner that enables airflow (or forced air) to flow or otherwise move through or between those connected components, such that the airflow is conveyed from a first of the connected components to the last of the connected components. As an illustrative example, if the second end 416 of the duct 402 was connected directly to an air source, those two components would be airflow communication. If piping or tubing connected the second end 416 of the duct 402 to the air source, then the duct 402, piping, and air source would all be in airflow communication. In an example embodiment, the multimodal debris clearing apparatus 400 has a brush 406 attached below or adjacent to the air outlet 412 at or near the first end 410 of the duct 402, with the magnet 408 positioned closely adjacent the brush 406. In some embodiments, the multimodal debris clearing apparatus 400 may be selectively deployable, with the multimodal debris clearing apparatus 400 being raised or lowered from a beam or other structural element of an autonomous vehicle. As an illustrative example, the multimodal debris clearing apparatus 400 may be deployable via a positioning system that may include any suitable combination of motors, gearing, electronic actuators, and/or pneumatic or hydraulic cylinders.

In an example embodiment, the multimodal debris clearing apparatus 400 may utilize airflow 404 as at least one mode for clearing or removing debris from the proximity of an autonomous vehicle. The airflow 404 is directed from the multimodal debris clearing apparatus 400 onto the road surface, in the direction of travel of the autonomous vehicle, ahead of the autonomous vehicle. The airflow redirects the debris on the road surface outward from the path of the autonomous vehicle. to blow away debris from the road surface. In at least one example embodiment, the airflow 404 is directed from an air outlet 412 of the duct 402. In some embodiments, the air outlet 412 may be divided into two or more openings by one or more dividers 414. The front portion of the air outlet 412 may also be shaped or angled to direct airflow 404 in a particular direction. In some embodiments, the one or more dividers 414 may assist in directing airflow 404 in a particular direction as the airflow 404 exits the air outlet 412. The duct 402 of the multimodal debris clearing apparatus 400 receives forced air from a blower, pneumatic, or similar air generating system (not shown).

In an example embodiment, the multimodal debris clearing apparatus 400 may utilize a brush 406 or similar means of physically agitating or pushing debris as at least one mode for clearing or removing debris proximate the path of an autonomous vehicle. In at least one example embodiment, the brush 406 can be affixed to the bottom portion of the multimodal debris clearing apparatus 400. The multimodal debris clearing apparatus 400 can be positioned in relation to the autonomous vehicle so that the brush 406 is placed in contact with the road surface to push or otherwise physically move debris from the proximity of the autonomous vehicle. In an example embodiment, the brush 406 is configured to be removably attached to the multimodal debris clearing apparatus 400 so that the brush 406 may be replaced as the brush 406 becomes worn or if the brush 406 is broken. The brush 406 may attach to the multimodal debris clearing apparatus 400 using (i) a snap-fit or similar interlocking connection between the brush 406 and the multimodal debris clearing apparatus 400, (ii) a removable connector, such as a screw or bolt, that secures the brush 406 to the multimodal debris clearing apparatus 400, (iii) a latch or locking mechanism between the brush 406 and the multimodal debris clearing apparatus 400, or (iv) any other suitable attachment means that would be obvious to one of skill in the art.

In an example embodiment, the multimodal debris clearing apparatus 400 may utilize a magnet 408 as at least one mode for clearing or removing debris from the proximity of an autonomous vehicle. The magnet 408 can serve as a collection mode to complement the deflection modes provided by the airflow 404 and brush 406, with the magnet 408 capturing debris that is not deflected by the airflow 404 or brush 406. In at least one example embodiment, the magnet 408 can be affixed to the bottom portion of the multimodal debris clearing apparatus 400. In some embodiments, the magnet 408 is positioned behind the brush 406, in the direction of travel of the autonomous vehicle, whereas in other embodiments the magnet 408 is positioned in front of the brush 406. The multimodal debris clearing apparatus 400 can be positioned in relation to the autonomous vehicle so that the magnet 408 is placed sufficiently close to the road surface so that the magnetic force of the magnet 408 can attract and capture debris from the road surface. In an example embodiment, the magnet 408 is configured to be removably attached to the multimodal debris clearing apparatus 400 so that the magnet 408 may be replaced as needed. The magnet 408 may attach to the multimodal debris clearing apparatus 400 using (i) a snap-fit or similar interlocking connection between the magnet 408 and the multimodal debris clearing apparatus 400, (ii) a removable connector, such as a screw or bolt, that secures the magnet 408 to the multimodal debris clearing apparatus 400, (iii) a latch or locking mechanism between the magnet 408 and the multimodal debris clearing apparatus 400, or (iv) any other suitable attachment means that would be obvious to one of skill in the art. In an example embodiment, the magnet 408 may be a static/permanent magnet or an electromagnet. In embodiments where the magnet 408 is an electromagnet, the magnet 408 is configured to draw power for the autonomous vehicle's power supply. In embodiments where the magnet 408 is an electromagnet, the magnet 408 is configured to be selectively activated so that collected debris can be easily dropped and collected from the magnet 408.

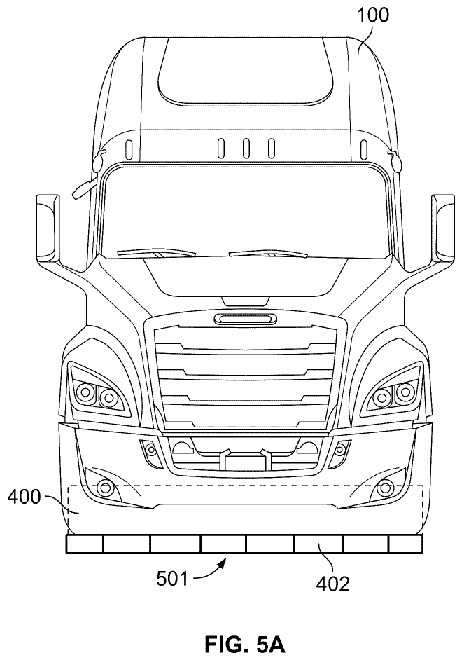

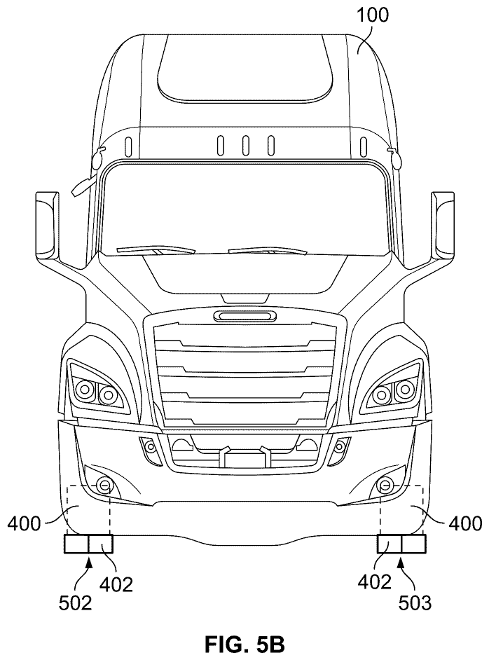

FIGS. 5A and 5B are front elevation views of an autonomous vehicle with one or more units of the multimodal debris clearing apparatus 400 across the front of the autonomous vehicle 100. In the example embodiment of FIG. 5A, the one or more units of the multimodal debris clearing apparatus 400 are positioned across the entirety of the front of the autonomous vehicle 100, which may include a plurality of ducts 402 across the front of the autonomous vehicle 100. In the example embodiment of FIG. 5B, the one or more units of the multimodal debris clearing apparatus 400 are positioned only in front of the front wheels of the autonomous vehicle 100, which may include one or more ducts 402 in front of each front wheel of the autonomous vehicle 100. As an illustrative example shown in FIG. 5A, the multimodal debris clearing apparatus 400 may be configured as a continuous array 501 across the entire front of the autonomous vehicle 100. The multimodal debris clearing apparatus 400 may be modularized, utilizing one or more ducts 402 so that one duct 402 may be replaced without the need to replace the entire array 501. As an illustrative example shown in FIG. 5B, a first multimodal debris clearing apparatus 400 may be configured as a first array 502 in front of a first front wheel of the autonomous vehicle 100 and a second multimodal debris clearing apparatus 400 may be configured as a second array 503 in front of a second front wheel of the autonomous vehicle 100. Each multimodal debris clearing apparatus 400 may be modularized by employing one or more ducts 402 so that one duct 402 may be replaced without the need to replace the entirety of either array 502 or 503.

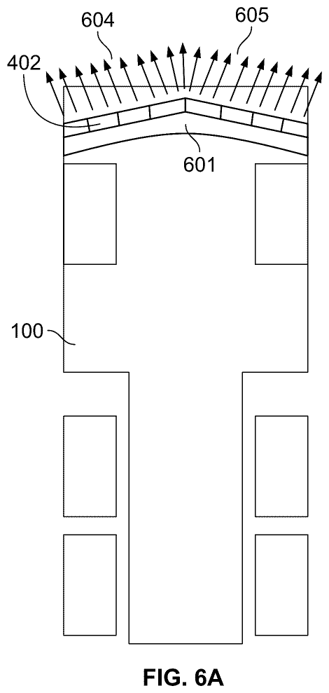

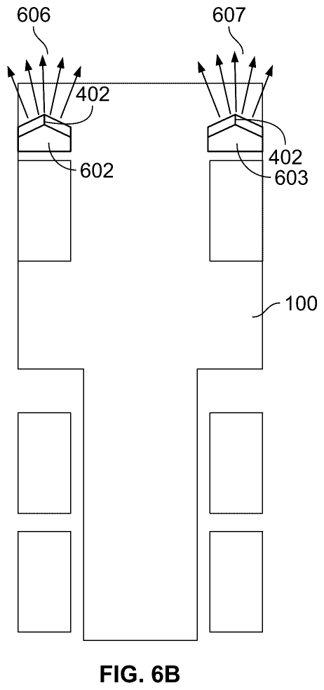

FIGS. 6A and 6B, which correspond to FIGS. 5A and 5B, are bottom plan views of an autonomous vehicle 100 with one or more units of the multimodal debris clearing apparatus across the front of the autonomous vehicle 100. In the example embodiment of FIG. 6A, the one or more units of the multimodal debris clearing apparatus are positioned across the entirety of the front of the autonomous vehicle 100, which may include a plurality of ducts 402 across the front of the autonomous vehicle 100. In the example embodiment of FIG. 6B, the one or more units of the multimodal debris clearing apparatus are positioned only in front of the front wheels of the autonomous vehicle 100, which may include one or more ducts 402 in front of each front wheel of the autonomous vehicle 100.

As an illustrative example shown in FIG. 6A, the one or more units of the multimodal debris clearing apparatus may be a continuous array 601 across the entire front of the autonomous vehicle 100. In some embodiments, as shown in FIG. 6A, the plurality of ducts 402 constructing the array 601 may be angled and/or offset. Angling and/or offsetting the ducts 402 of the array 601 creates a first angled airflow 604 and a second angled airflow 605 that can deflect debris away from the center of the autonomous vehicle 100 and to the sides of the autonomous vehicle 100.

As an illustrative example shown in FIG. 6B, the one or more units of the multimodal debris clearing apparatus may be a first array 602 and a second array 603 positioned in front of a first front wheel and a second front wheel, respectively, of the autonomous vehicle 100. In some embodiments, as shown in FIG. 6B, the plurality of ducts 402 constructing the arrays 602/603 may be angled and/or offset. Angling and/or offsetting the ducts 402 of the arrays 602/603 creates a first angled airflow 606 and a second angled airflow 607 that can deflect debris away from the first front wheel and second front wheel, respectively, of the autonomous vehicle 100.

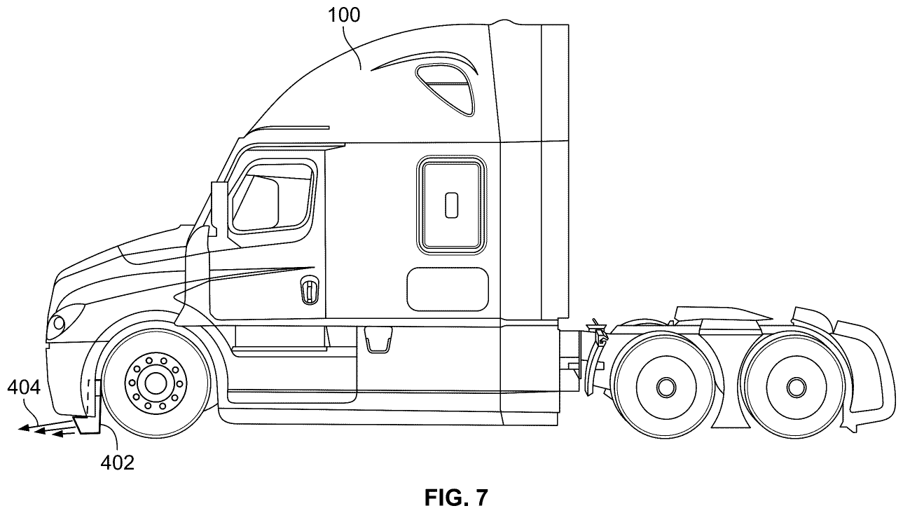

FIG. 7 is a side elevation view of an autonomous vehicle with the multimodal debris clearing apparatus of FIG. 4 deployed at the front of the autonomous vehicle. In an example embodiment, the duct 402 of the multimodal debris clearing apparatus may be movably attached inside the bumper or wheel well of an autonomous vehicle 100. The duct 402 is configured to be movable between a retracted position and a deployed position. In the deployed position, the duct 402 is configured to distribute airflow 404 at the front of the autonomous vehicle 100.

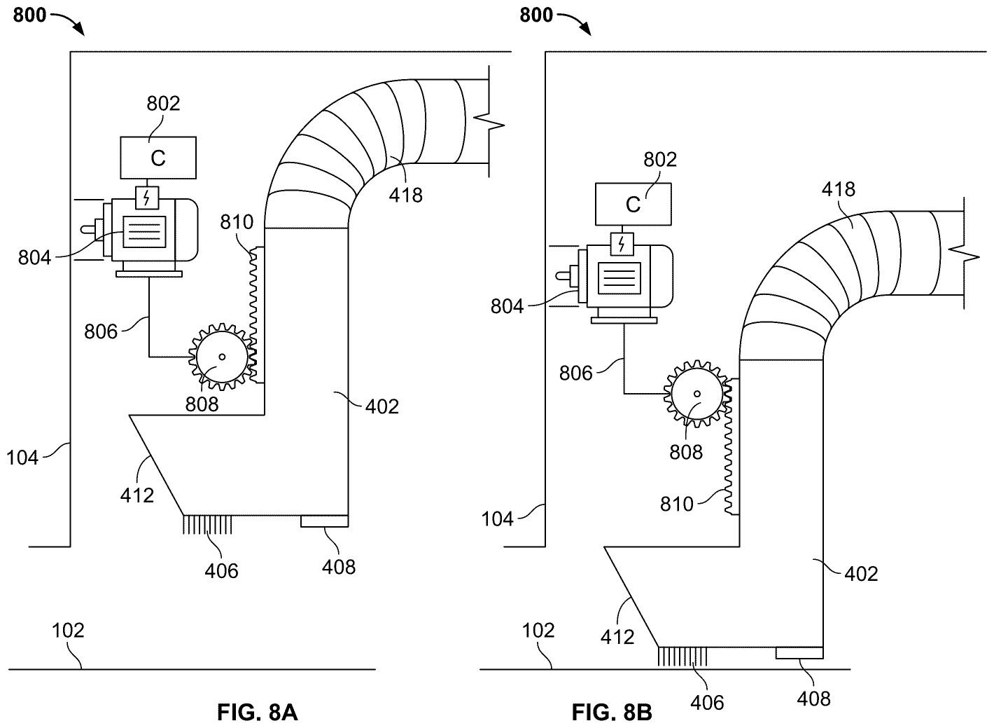

FIG. 8A is a schematic view of the multimodal debris clearing apparatus of FIG. 4 in a raised or retracted position, along with a duct positioning system. In an example embodiment, the duct 402 of the multimodal debris clearing apparatus is retracted within or behind the bumper/wheel well 104 of an autonomous vehicle. In the example embodiment, the autonomous vehicle includes a duct positioning system 800. In an example embodiment, the duct positioning system 800 includes a controller 802, motor 804, mechanical, electrical, and data connections 806, a drive gear 808, and a linear gear 810.

In an example embodiment, the linear gear 810 may be attached to or integrally formed on the duct 402. The linear gear 810 is aligned on the duct 402 so that the linear gear 810 is in mechanical communication with the driven gear 808. The driven gear 808 is powered by a motor 804, which is controlled by a controller 802. The controller 802, motor 804, and driven gear are operatively connected by a set of mechanical, electrical, and data connections 806. Functions of the mechanical, electrical, and data connections 806 may include, but are not limited to, (i) providing electrical power to the motor 804, (ii) carrying control signals between the controller 802 and the motor 804, and (iii) transferring mechanical power from the motor 804 to the drive gear 808 (e.g. via a drive shaft).

In an alternate example embodiment, the functions of the motor 804, drive gear 808, and linear gear 810 may be fulfilled by an electronic actuator. In the example embodiment, the electronic actuator may include a motor, a gear box, a leadscrew, and an actuator shaft/piston, along with components known to one of skill in the art. In the alternate example embodiment, the electronic actuator may be connected between the duct 402 and a mounting point on or near the bumper/wheel well 104 of an autonomous vehicle.

In another alternate example embodiment, the functions of the motor 804, drive gear 808, and linear gear 810 may be fulfilled by a pneumatic or hydraulic cylinder, along with the auxiliary components to support the pneumatic or hydraulic cylinder (e.g. pneumatic/hydraulic pumps, hoses, valves, and other components known to one of skill in the art). In the other alternate example embodiment, the pneumatic or hydraulic cylinder may be connected between the duct 402 and a mounting point on or near the bumper/wheel well 104 of an autonomous vehicle.

FIG. 8B is a schematic view of the multimodal debris clearing apparatus of FIG. 4 in a lowered or deployed position, along with a duct positioning system. In an example embodiment, the duct 402 of the multimodal debris clearing apparatus is lowered from within or behind the bumper/wheel well 104 of an autonomous vehicle. The end of the duct 402 (the end opposite the air outlet 412) may be attached to a flexible, extendible, or otherwise adjustable segment of tubing or piping 418 having a dynamically changeable length to facilitate the raising and lowering of the duct within the bumper/wheel well 104. In the example embodiment, the duct 402 is lowered to a position where (i) the 412 air outlet is clear of the bumper/wheel well 104 to permit airflow from the air outlet 412 to be effectively delivered to the ground 102, (ii) the brush 406 is in contact with the ground 102 to physically deflect debris that is not blown away by the airflow, and (iii) the magnet 408 is sufficiently close to the ground 102 to collect debris that is not physically deflected by the brush 406.

In an example embodiment, referring also to FIG. 2, the controller 802 is in signal communication with the debris monitoring and clearing module 242. The debris monitoring and clearing module 242 receives data from the sensors 202 that includes, but is not limited to, (i) debris that is in the path of the autonomous vehicle as detected by the sensors 202 and (ii) the speed of the autonomous vehicle. Depending on the type of debris detected and the speed of the autonomous vehicle, the debris monitoring and clearing module 242 can signal the controller 802 to activate the duct positioning system 800 to deploy or retract the duct 402 as the control logic dictates according to the conditions sensed by the sensors 202. In an example embodiment, the debris monitoring and clearing module 242 may only signal the controller 802 to activate the duct positioning system 800 to deploy (i.e. lower) the duct 402 when (i) debris is detected by one or more of the sensors 202 and (ii) the speed of the autonomous vehicle is below a certain threshold speed (e.g. 15 miles per hour).

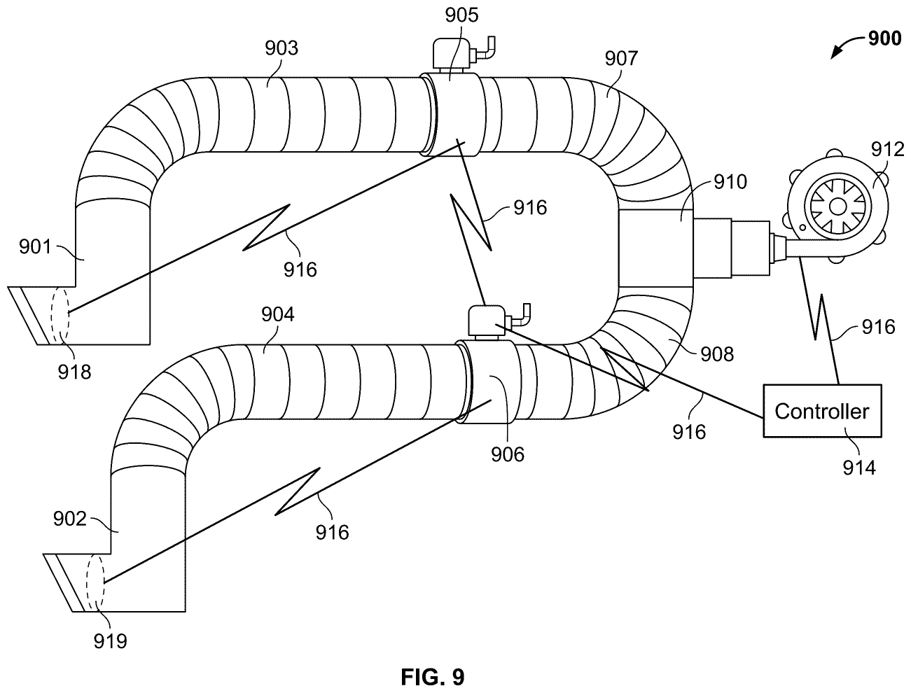

FIG. 9 is a schematic view of a multimodal debris clearing system. In an example embodiment, the multimodal debris clearing system 900 includes a plurality of multimodal debris clearing apparatuses 901/902, a plurality of first tubing segments 903/904, a plurality of valves 905/906, a plurality of second tubing segments 907/908, a tubing splitter 910, an airflow generator 912, a controller 914, and a plurality of electrical/signal connections 916, and a vent flap or shutter mechanism 918/919 in each of the multimodal debris clearing apparatuses 901/902. In the example embodiment, the airflow generator 912 may be a motorized blower or the pneumatic system of the vehicle. The airflow generator 912, as controlled by the controller 914 via an electrical/signal connection 916, supplies airflow to the multimodal debris clearing system 900.

As airflow is generated by the airflow generator 912, airflow passes through the tubing splitter 910, which splits the airflow between a first side and a second side of the multimodal debris clearing system 900, beginning with the respective second tubing segments 907/908. A valve 905/906 is positioned between the first tubing segments 903/904 and the second tubing segments 907/908. The valve 905/906, as controlled by the controller 914 via the electrical/signal connections 916, is configured to regulate airflow through the multimodal debris clearing system 900 by opening or closing each side of the multimodal debris clearing system 900, which in turn permits airflow to be selectively supplied to each of the multimodal debris clearing apparatuses 901/902 via the first tubing segments 903/904. Airflow arriving at each of the multimodal debris clearing apparatuses 901/902 may be further directed or controlled by a vent flap or shutter mechanism 918/919 in each of the multimodal debris clearing apparatuses 901/902. For example, the vent flap or shutter mechanism 918/919, as controlled by the controller 914 via the electrical/signal connections 916, can be moved between an open and closed position to direct or prevent airflow to any of the air outlets in the multimodal debris clearing apparatuses 901/902.

While FIG. 9 presents an example embodiment for a layout of a multimodal debris clearing system, the multimodal debris clearing system of the present disclosure is contemplated as being highly modular and capable of being modified in terms of both the arrangement and numbers of each component, as well as the combination or deletion of certain components. For example, instead of having a single airflow generator for a bifurcated or otherwise split system, the system could have multiple airflow generators, such as one airflow generator for each multimodal debris clearing apparatus. Such an arrangement could support the selective activation of each multimodal debris clearing apparatus by activating the airflow generator attached to each multimodal debris clearing apparatus, without the need to rely on a system of valves and tubing. As another example, the valves could be integrated directly into outlets on a splitter, with the splitter having any number of outlets to connect to a corresponding number of multimodal debris clearing apparatuses. Additionally, the vehicle could employ multiple individual multimodal debris clearing systems positioned on different portions of the vehicle. One of ordinary skill in the art would appreciate that the multimodal debris clearing system of the present disclosure could be configured with any number and arrangement of tubing, splitters, and valves as necessary to connect between any number of airflow generators and multimodal debris clearing apparatuses. Additionally, the modular nature of the multimodal debris clearing system enables case of maintenance, as any one component can be replaced without the need to replace the entire system.

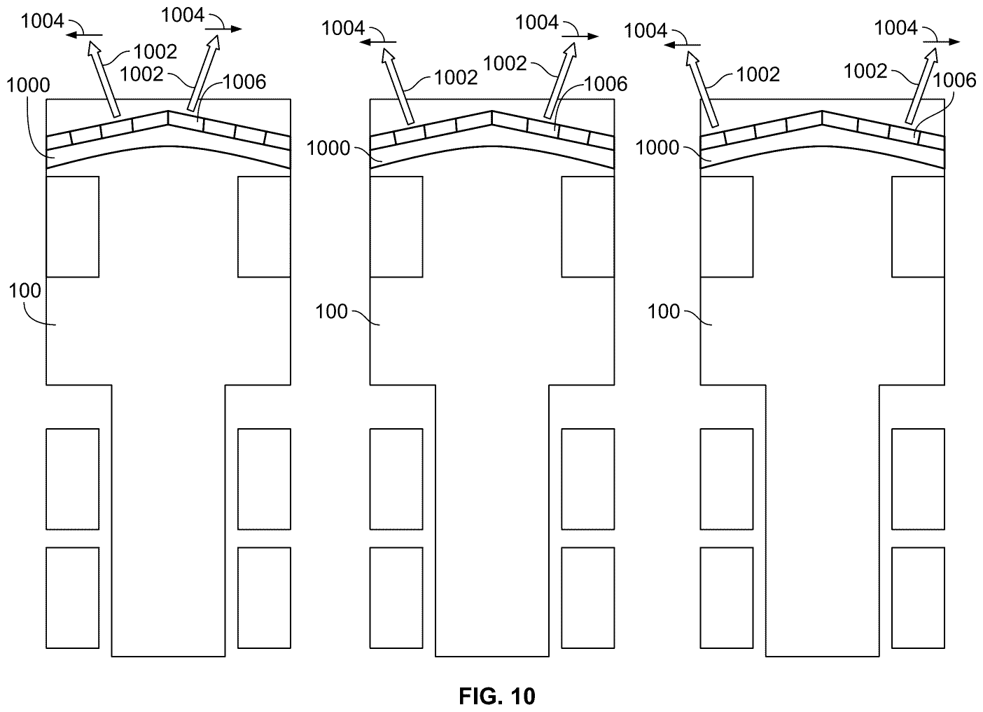

FIG. 10 is a bottom plan view of an autonomous vehicle equipped with a multimodal debris system illustrating an exemplary pattern of airflow from the multimodal debris system. In an example embodiment, airflow 1002 through the multimodal debris system 1000 can be controlled such that airflow 1002 is expelled in a pattern through particular air outlets 1006 of the multimodal debris system 1000. In one example embodiment, airflow 1002 can be expelled through particular air outlets 1006 to create a sweeping pattern 1004 toward the edge of autonomous vehicle 100. Other patterns of airflow are also possible by activating air outlets in a pattern to create the desired effect.

The multimodal debris clearing system of the present disclosure may also include operational logic for controlling the multimodal debris clearing system and the components thereof. In an example embodiment, the control logic may be stored and executed by the debris monitoring and clearing module 242. In the example embodiment, at least two conditions relevant to the deployment and activation of the multimodal debris clearing system may be (i) the detection of debris by one or more of the sensors 202 and (ii) the speed of the vehicle. As an illustrative example, the multimodal debris clearing system may only be activated by the debris monitoring and clearing module 242 when, as a first condition, debris is detected in the path of the vehicle and, as a second condition, the speed of the vehicle is at or below a determined speed. In some examples, the detection of debris condition may be a prerequisite condition before the vehicle speed condition is considered. The debris monitoring and clearing module 242 could be programmed with multiple control logics. For example, the debris monitoring and clearing module 242 could be programmed to automatically lower the multimodal debris clearing apparatus at a predetermined vehicle speed, with the activation of airflow through the multimodal debris clearing apparatus occurring either (i) automatically or (ii) only when debris is detected. In embodiments where the multimodal debris clearing apparatus utilizes an electromagnet, the debris monitoring and clearing module 242 could selectively activate the magnet under similar logic.

In addition to the control logics of the debris monitoring and clearing module 242 related to the deployment and activation of the multimodal debris clearing system, the debris monitoring and clearing module 242 may include control logic for to the retraction and deactivation of the multimodal debris clearing system. As an illustrative example, the multimodal debris clearing system could be retracted and deactivated when (i) the sensors 202 no longer detect debris in the path of the vehicle, (ii) the speed of the vehicle is above a determined speed, or (iii) a combination thereof.

The debris monitoring and clearing module 242 could be programmed with additional control logics with respect to specific components or segments of the multimodal debris clearing system. As an illustrative example, referring to FIG. 9, the debris monitoring and clearing module 242 may only deploy and activate a portion of the multimodal debris clearing system by, for example, opening valve 905 and closing valve 906 to direct airflow only to multimodal debris clearing apparatus 901. Similarly, the multimodal debris clearing apparatus 901 may be the only the only one that is lowered. Such an example of operation may be useful when debris is detected only on one side of the vehicle. As another illustrative example, referring to FIG. 10, the debris monitoring and clearing module 242 may include programming to create different patterns of airflow 1002 from the air outlets 1006 of the multimodal debris system 1000. Such an example of operation may, in reference to FIG. 9, be enabled by the debris monitoring and clearing module 242 providing control logic for the vent flap or shutter mechanism 918/919 in each of the multimodal debris clearing apparatuses 901/902.

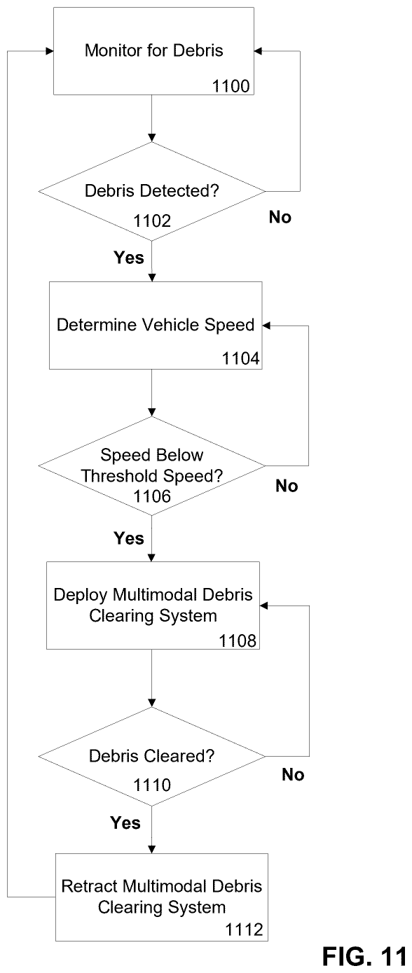

FIG. 11 is an exemplary flow chart illustrating the activation of a multimodal debris clearing system. In an example embodiment, at 1100, the sensors 202 of an autonomous vehicle 100 continuously monitor for debris. At 1102, a determination is made regarding the detection of debris. The determination at 1102 is based, at least in part, on whether the sensors 202 and debris monitoring and clearing module 242 determine that there is debris in the path of the autonomous vehicle 100. If a negative determination is made at 1102, the process continues at 1100 and monitoring for debris continues. If a positive determination is made at 1102, the process continues at 1104 in which the speed of the autonomous vehicle is determined. Upon determining the vehicle speed in 1104, the process continues with determination at 1106, in which it is determined whether the autonomous vehicle 100 is below a determined threshold speed. If a negative determination is made at 1106, the process continues at 1104, during which time the speed of the autonomous vehicle 100 may be adjusted by the autonomy computing system 200. If a positive determination is made at 1106, the process continues with 1108 in which the multimodal debris clearing system is deployed to clear the debris from the path of the autonomous vehicle 100. At 1110, a determination is made regarding whether the debris has been cleared. The determination at 1110 is based, at least in part, on whether the sensors 202 and debris monitoring and clearing module 242 determine that the debris has been cleared from the path of the autonomous vehicle 100. If a negative determination is made at 1110, the process continues at 1108 and the multimodal debris clearing system remains deployed to clear the debris. If a positive determination is made at 1110, the process continues at 1112 in which the multimodal debris clearing system is retracted. The process then continues to 1100 with the continued monitoring for debris.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, and algorithms, described above may be implemented as electronic hardware, software, or combinations of both. Certain disclosed components, blocks, modules, circuits are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element recited in the singular and proceeded with the word “a” or “an” should be understood as not excluding plural elements unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A multimodal debris clearing system for a vehicle, comprising:
an airflow generator;
one or more multimodal debris clearing apparatuses in airflow communication with the airflow generator, wherein each of the multimodal debris clearing apparatuses includes a duct configured to direct an airflow toward a front end of the vehicle;
one or more secondary debris clearing modes attached to at least one of the one or more multimodal debris clearing apparatuses; and
a debris monitoring and clearing module programmed with control logic to activate the airflow generator when debris is detected.

2. The multimodal debris clearing system of claim 1, further comprising a duct positioning system configured to move the multimodal debris clearing apparatuses between a retracted position and a deployed position.

3. The multimodal debris clearing system of claim 2, wherein the control logic of the debris monitoring and clearing module is further programmed to activate the duct positioning system when the debris is detected.

4. The multimodal debris clearing system of claim 1, further comprising an airflow splitter positioned between the airflow generator and each of the multimodal debris clearing apparatuses.

5. The multimodal debris clearing system of claim 1, wherein at least one of the multimodal debris clearing apparatuses are positioned in front of each front wheel of the vehicle.

6. The multimodal debris clearing system of claim 1, wherein the multimodal debris clearing apparatuses are spaced across the front end of the vehicle.

7. The multimodal debris clearing system of claim 1, wherein an air outlet at a first end of at least one of the multimodal debris clearing apparatuses is divided into two or more openings by a divider.

8. The multimodal debris clearing system of claim 7, wherein the air outlet has a V-shape and the divider is positioned to direct the airflow outward from a center line of the V-shape of the air outlet.

9. The multimodal debris clearing system of claim 1, further comprising:
one or more airflow valves; and
a controller to selectively activate the one or more valves.

10. The multimodal debris clearing system of claim 1, further comprising:
a flap mechanism inside of the duct of a plurality of the multimodal debris clearing apparatuses, wherein the flap mechanism is movable between an open position and a closed position; and
a controller to selectively activate the flap mechanism between the open position and the closed position.

11. The multimodal debris clearing system of claim 10, wherein the flap mechanism of each of the plurality of multimodal debris clearing apparatuses is activated in a pattern to impart a sweeping effect to the airflow as the airflow exits the multimodal debris clearing apparatuses.

12. The multimodal debris clearing system of claim 1, wherein the one or more secondary debris clearing modes are selected from a group comprising a brush and a magnet.

13. The multimodal debris clearing system of claim 1, wherein the one or more secondary debris clearing modes are removably attached to the one multimodal debris clearing apparatus.

14. A multimodal debris clearing system for a vehicle, comprising:
an airflow generator;
one or more multimodal debris clearing apparatuses in airflow communication with the airflow generator, wherein each of the multimodal debris clearing apparatuses includes a duct configured to direct airflow toward a front end of the vehicle via an air outlet formed at a first end of the duct;
a duct positioning system configured to move the multimodal debris clearing apparatuses between a retracted position and a deployed position;
a debris monitoring and clearing module programmed with control logic to activate both the airflow generator and the duct positioning system when debris is detected.

15. The multimodal debris clearing system of claim 14, the debris monitoring and clearing module is programmed with additional control logic to activate both the airflow generator and the duct positioning system when the vehicle is traveling below a threshold speed.

16. The multimodal debris clearing system of claim 14, further comprising one or more secondary debris clearing modes removably attached to at least one of the one or more multimodal debris clearing apparatuses.

17. The multimodal debris clearing system of claim 14, further comprising an adjustable pipe attached a second of the duct to enable the duct positioning system moving each of the multimodal debris clearing apparatuses between the retracted position and the deployed position.

18. A method of deploying a debris clearing system of a vehicle, comprising:
monitoring for a debris in a path of the vehicle;
detecting the debris in the path of the vehicle, wherein the debris is a detected debris;
deploying the debris clearing system; and
clearing the detected debris from the path of the vehicle using one or modes of clearing equipped on the debris clearing system.

19. The method of claim 18, wherein debris clearing system is deployable at front end of the vehicle and the one or modes of clearing are selected from a group of clearing modes comprising an airflow, a brush, and a magnet.

20. The method of claim 18, further comprising detecting a speed of the vehicle, wherein deploying the debris clearing system is limited to when the speed of the vehicle is at or below a threshold speed.
